(19) United States
(12) Patent Application Publication
(10) Pub. No.: US 2015/0178440 A1
(43) Pub. Date: Jun. 25, 2015

(54) Method and Device for Creating System Layout of Photovoltaic Open-Space Power Plant Having Solar Trackers

(71) Applicant: SIEMENS AKTIENGESELLSCHAFT, München (DE)

(72) Inventors: Rafael Fink, Munchen (DE); Marina Tvorogova, Braunschweig (DE)

(21) Appl. No.: 14/408,087

(22) PCT Filed: Apr. 16, 2013
(86) PCT No.: PCT/EP2013/057909

§ 371 Date: Dec. 15, 2014

(30) Foreign Application Priority Data
Jun. 15, 2012 (DE) 10 2012 210 132.2

(51) Int. Cl. G06F 17/50

(52) U.S. Cl. CPC G06F 17/5081

(57) ABSTRACT

A method for creating a system layout of a photovoltaic open-space power plant includes: providing configuration data for the photovoltaic open-space power plant and components thereof, predefined configuration rules for the photovoltaic open-space power plant, and configuration parameters that define the configuration rules; and optimizing allocation of location of the components of the power plant in a system layout matrix, wherein the system layout matrix images a site for the photovoltaic open-space power plant using the configuration data and the defined configuration rules to create the system layout of the photovoltaic open-space power plant.

### RELATED APPLICATIONS

This application is the National Stage of International Application No. PCT/EP2013/057909, filed Apr. 16, 2013, which claims the benefit of German Patent Application No. DE 102012210132.2, filed Jun. 15, 2012. The entire contents of both documents are hereby incorporated herein by reference.

### TECHNICAL FIELD

The present teachings relate generally to methods and devices for creating a system layout of a photovoltaic open-space power plant having power plant components (e.g., solar trackers).

### BACKGROUND

The location-based planning and installation of photovoltaic open-space power plants is a bottleneck in conventional development methods. The layout of photovoltaic systems is individualized for each system with the aid of spreadsheet-based planning that is manually carried out by experts (or is created in full by a planner).

These conventional methods are very time-consuming and prone to error due to the enormous volume of data. Due to the changing prerequisites from system to system (e.g., the outline of the area to be planned, regional regulations or the like), photovoltaic open-space power plants that have already been designed in the planning of other systems may not be reused or adapted. As a result, comprehensive, independent planning may be carried out for each system.

In the rough planning of systems involved in preparing a tender, aspects may be disregarded as a result of a frequently brief submission period. The aspects are then dealt with only during detailed planning. As a result, there may be a large uncertainty factor with regard to the promises made in the tender.

The planners previously received software support only in choosing certain configuration parameters. For example, software tools that may be used to determine the dependence of the power of a photovoltaic open-space power plant on solar irradiation data and on the position of the area to be planned for the photovoltaic open-space power plant have been described.

DE 33 01 046 C1 describes tracking devices for orienting devices according to an arcuate path. The described tracking devices are suitable, for example, for solar devices such as photovoltaic generators, solar cookers, and heliostats. The devices to be tracked may be arranged such that the devices may be rotated about a vertical axis. The tilting about a horizontal axis may be achieved with the rotation about the vertical axis by at least one guide element. The guide element of the tracking devices connects the tracked part with a fixed support point.

DE 203 14 665 U1 describes an arrangement for two-dimensionally covering area elevations such as bulk material or spoil heaps, noise protection walls or flood dams, or other open spaces having an at least partially inclined and/or curved surface. A supporting structure for accommodating covering elements is provided. The supporting structure is fitted with at least one covering element that is arranged at a distance from the surface of the area elevation and that at least partially covers the surface of the area elevation.

The documents entitled “Optimal Spacing of Dual-axis Trackers for Concentrating Photovoltaic Systems” and “Modeling of a Concentrating Photovoltaic System for Optimum Land Use” by Yong Sin Kim, and the document entitled “Tracking and Ground Cover Ratio” by L. Navarte describe methods for optimizing the position of solar trackers.

### SUMMARY AND DESCRIPTION

The scope of the present invention is defined solely by the appended claims, and is not affected to any degree by the statements within this summary.

The present embodiments may obviate one or more of the drawbacks or limitations in the related art. For example, in some embodiments, a method and a device are provided that, in accordance with configuration rules and configuration parameters, facilitate planning and installation of a photovoltaic open-space power plant with solar trackers on the basis of specified configuration and area data.

Planning software is provided that may automatically calculate the system layout, inter alia, while optimizing the connection of power plant components and optimizing the layout of photovoltaic open-space power plants having solar trackers.

The factors that are decisive for planning the layout of a system (e.g., the placement of the power plant components using the area available for the photovoltaic open-space power plant) are optimized.

One technical challenge is to correctly model the sub-problems of a problem to be solved. Another technical challenge is the achievable speed of calculating solutions in an automated manner on a computer.

A short calculation time is an important factor. The method in accordance with the present teachings calculates an optimized layout even for large systems within a few minutes, thereby significantly reducing planning time as compared to conventional manual planning.

A graphical user interface provides all of the functionalities to plan the system of the photovoltaic open-space power plant in a user-friendly manner. These functionalities include, inter alia, the input of data, the optimization core, the visualization of the solution, and the export of the results for further processing in computer-aided design or cost calculation tools.

The complete optimization problem addressed by the method in accordance with the present teachings has a high degree of complexity and is therefore solved by a hierarchical approach (e.g., decomposition of the problem into subunits). Even the individual problems produced by the decomposition may be difficult to solve and rely upon the provision of specialized and complex calculation methods.

The problem addressed by the method in accordance with the present teachings includes an optimizer in the form of a plurality of technical algorithms that are used to solve the overall problem.

Configuration rules are, on one hand, physical secondary conditions to be complied with and, on the other hand, rules that have been stipulated with regard to standardizing the system layouts or for facilitating construction and servicing by experts of the system of the photovoltaic open-space power plant.

The configuration rules are concretized (e.g., defined) by stipulating specific values for configuration parameters. The configuration data specify the photovoltaic open-space power plant to be planned and the power plant components of the photovoltaic open-space power plant.

A system layout may be created as the configuration of the photovoltaic open-space power plant. The system layout may be created to place the solar trackers with the photovoltaic modules, to position service and cable routes between the solar trackers, to place inverters, and to assign the solar trackers to inverter groups.

For the “different standard blocks” application, a system layout may be determined wherein the solar trackers in an inverter group are positioned on the available area in different rectangular standard configurations (e.g., standard blocks) that are predefined by the user. Continuous routes run between the standard blocks. In addition, each of the standard blocks is assigned an inverter. The relative placement of the inverter inside the standard block is predefined by the user. As a result of the cabling inside a standard block, the entire direct current produced in the associated solar trackers is conducted to the inverter.

According to the optimization task, a suitable, optimized system layout may be calculated in a short time (e.g., within a few minutes) in an automated manner taking into account the configuration rules.

Examples of objectives in accordance with the present teachings may be to achieve optimum use of the available area or the creation of optimum prerequisites for simple, efficient, and cost-effective cabling of the power plant components of the photovoltaic open-space power plant.

The optimization task involves calculating a system layout of the photovoltaic open-space power plant that is optimized in terms of nominal power, efficiency, and costs, and that takes into account the configuration rules within a short time (e.g., within a few minutes).

In some embodiments, the power plant components to be positioned are solar trackers. The power plant components are positioned such that the solar trackers are divided into a plurality of inverter groups. Each inverter group of the plurality of inverter groups forms a standard block.

In some embodiments, the standard blocks may be in the form of rectangular standard blocks. Such embodiments may provide advantageous planning of the cable and service routes.

In some embodiments, the standard blocks may be in the form of different types of standard blocks. Inside the inverter groups, cabling of the power plant components may be provided that is as simple, efficient, and cost-effective.

In some embodiments, maximization of the inverter groups may be used as a target function to create the system layout of the photovoltaic open-space power plant.

In some embodiments, the different types of standard blocks may be included in the target function used with different weightings when maximizing the number of inverter groups. Such embodiments may provide a photovoltaic open-space power plant having improved solutions to the system layout and connection problems. The solar trackers may be assigned to inverter groups on the basis of the calculated positioning.

In some embodiments, at least two system layout matrices may be used to optimize the positioning of power plant components.

In some embodiments, the number of solar trackers in the system layout of the photovoltaic open-space power plant may be maximized when optimizing the positioning of the power plant components. Such embodiments may increase the total power of the photovoltaic open-space power plant.

In some embodiments, the creation of the system layout of the photovoltaic open-space power plant may include checking the compatibility of the power plant components with one another. Such embodiments may increase the operational reliability of the photovoltaic open-space power plant.

In some embodiments, data relating to a position and/or an outline of an area intended for the photovoltaic open-space power plant may be provided as the configuration data. Such embodiments may optimally adapt the photovoltaic open-space power plant to the local conditions.

In some embodiments, an optimization module having a plurality of algorithms may be used to create the system layout of the photovoltaic open-space power plant. The optimization module uses a plurality of calculation methods to plan and install the photovoltaic open-space power plant. As a result, the quality of calculated layouts may be gradually improved.

In some embodiments, a user interface module may be used to carry out the method. The user interface module is in the form of a graphical user interface and/or has functionalities for inputting data and/or for managing data and/or for outputting data and/or is configured to call the optimization module and/or to display results.

The user interface module facilitates secure and simple data communication between the user and the planning software.

The refinements and developments described herein may be combined with one another in any desired manner.

Additional refinements, developments, and implementations of the present teachings may also include combinations of features described above or below with respect to the exemplary embodiments even if such combinations have not been explicitly described.

### BRIEF DESCRIPTION OF THE DRAWINGS

The illustrated elements of the drawings may not be shown true to scale with respect to one another.

FIG. 1 shows an illustration of a flowchart of an exemplary method in accordance with the present teachings for creating a system layout of a photovoltaic open-space power plant.

FIG. 2 shows an illustration of a map view of an exemplary area to be planned for a photovoltaic open-space power plant in accordance with the present teachings.

FIG. 3 shows an illustration of an exemplary solar tracker of a photovoltaic open-space power plant in accordance with the present teachings.

FIG. 4 shows an illustration of a side profile of an exemplary solar tracker of a photovoltaic open-space power plant in accordance with the present teachings.

FIG. 5 shows an illustration of an exemplary inverter group of a photovoltaic open-space power plant in accordance with the present teachings.

FIGS. 6-8 each show an illustration of an exemplary system layout in accordance with the present teachings that may result from different specifications with respect to the arrangement of the solar trackers in the inverter groups.

FIG. 9 shows an illustration of an exemplary tracker route grid in accordance with the present teachings for creating a configuration of a photovoltaic open-space power plant with solar trackers that are arranged in standard blocks.

FIG. 10 shows an illustration of a flowchart of an exemplary method in accordance with the present teachings for creating a system layout of a photovoltaic open-space power plant.

FIG. 11 shows an illustration of an exemplary system layout matrix in the form of an area tracker matrix for the tracker route grid shown in FIG. 9 in accordance with the present teachings.

FIG. 12 shows an illustration of different types of exemplary standard blocks in accordance with the present teachings.

FIGS. 13-15 each show an illustration of an exemplary system layout matrix in accordance with the present teachings.

FIG. 16 shows an illustration of an exemplary user interface module for inputting data in accordance with the present teachings.

In the drawing figures, unless otherwise stated, identical reference symbols denote identical or functionally identical components or method acts.

### DETAILED DESCRIPTION

FIG. 1 shows an illustration of a flowchart of an exemplary method in accordance with the present teachings for creating a system layout of a photovoltaic open-space power plant.

In a first act S1 of the method, configuration data that specify the photovoltaic open-space power plant PV and the power plant components thereof, configuration rules that are predefined for the photovoltaic open-space power plant PV, and configuration parameters that concretize (e.g., define) the configuration rules are provided.

Power plant components are, for example, solar trackers, inverters, photovoltaic modules, solar cell strings, solar cell tables, connecting cables, coupling boxes, terminal boxes, inverter containers, or other electrical module components.

In a second method act, both the number of components of the photovoltaic open-space power plant PV and the positioning of the components are stipulated for system layout properties by initialization and subsequent optimization S2 using the provided configuration data and the defined configuration rules.

The data provided also include, for example, circuitry secondary conditions or other standard conditions or safety guidelines for the photovoltaic open-space power plant PV. Placement secondary conditions or secondary conditions for electrical variables of power plant components (e.g., maximum electrical current intensities or electrical voltages) are provided, for example, as circuitry secondary conditions.

For example, the configuration rules may be defined by stipulating specific values for the configuration parameters. Configuration data may specify, for example, the system to be planned or the system layout of the photovoltaic open-space power plant PV.

For example, a configuration parameter of eight solar trackers ST for each inverter group IG defines the configuration rules with respect to interconnecting the solar trackers ST to form one inverter group IG.

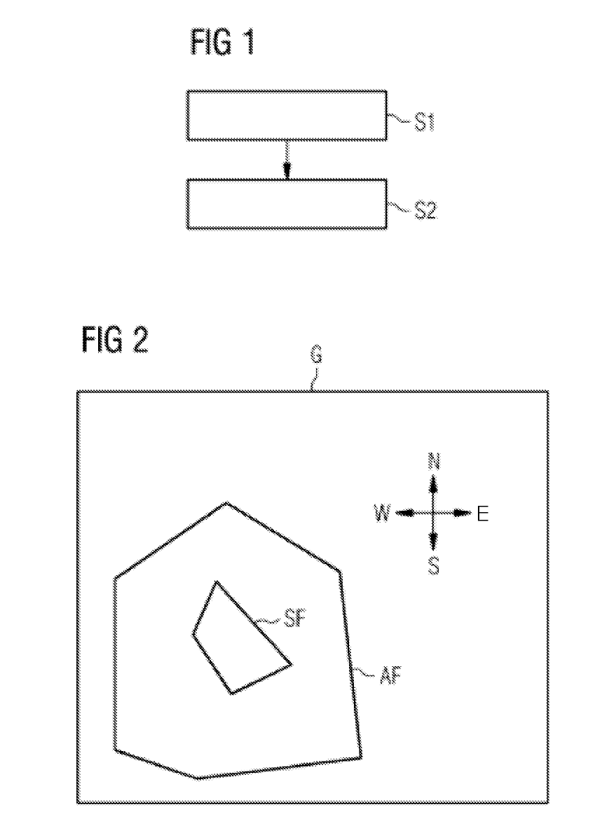

FIG. 2 shows an illustration of a map view of an exemplary area to be planned for a photovoltaic open-space power plant in accordance with the present teachings.

In an area G that may be defined by an outline and one or more barred areas SF, a photovoltaic open-space power plant PV is planned or erected in a system area AF. The configuration of the photovoltaic open-space power plant PV may be optimized according to nominal power and/or costs and/or efficiency.

The area G to be planned is illustrated in the depicted orientation. The west-east orientation, W-E, is given by the x coordinate and the north-south orientation, N-S, is given by the y coordinate.

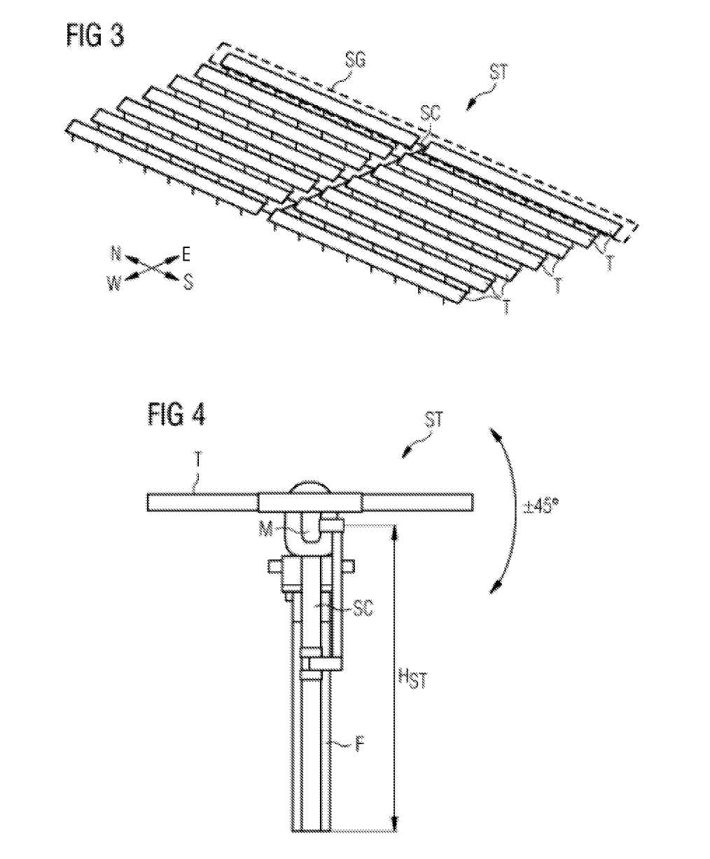

FIG. 3 shows an illustration of an exemplary solar tracker of a photovoltaic open-space power plant in accordance with the present teachings.

A plurality of identical photovoltaic modules of a photovoltaic open-space power plant PV are connected in series to form strings that are in turn connected to inputs of inverters of the photovoltaic open-space power plant PV in a parallel circuit. The number of photovoltaic modules in a string depends on the specification data for the inverters.

The specification data for the inverters are provided as data relating to the power plant components of the photovoltaic open-space power plant PV.

The photovoltaic modules that have been connected to form strings are mounted on a tracker frame on a solar tracker ST. The solar trackers ST are carrier systems that track the position of the sun. The carrier system, the mounted photovoltaic modules, the controller or similar components may be matched to one another in an integrated manner.

A tracker frame of the solar tracker ST includes a plurality of parallel segments SG running in the north-south direction. All segments SG of the solar tracker ST may be coupled to one another via a push rod. The push rod is driven by a motor M, runs centrally in the west-east direction, and facilitates adaptation of the orientation of the module to the position of the sun from east to west over the course of the day.

At sunrise, all of the photovoltaic modules on the solar tracker ST are oriented to the east. Over the course of the day, the inclination of the photovoltaic modules is adapted to the current position of the sun until, at sunset, the photovoltaic modules are oriented to the west. The position of the sun may be tracked in the solar trackers ST by single-axis rotation of the segments SG of the solar trackers ST.

FIG. 4 shows an illustration of a side profile of an exemplary solar tracker of a photovoltaic open-space power plant in accordance with the present teachings.

A solar tracker ST includes a wing T and a base F. The photovoltaic modules are mounted on the wing T. The base F is used to anchor the solar tracker ST in the ground.

A motor M is fitted between the base F and the wing T at a height H_{ST}, for example. The motor M may rotate the wing T via a push rod SC (e.g., over an angular range of +/−45°. The push rod SC runs in the center of the segments SG in the west-east direction and, therefore, subdivides each segment SG into a north wing and a south wing T.

The specification of the tracker design of the solar tracker ST by the user includes, for example, the selection of a multiplicity of design and configuration parameters of the solar tracker ST. For example, the design and configuration parameters of the solar tracker ST may include the selection of the module type used, the stipulation of the number of photovoltaic modules per wing T (including the mounting of the modules on the frame), the distance between a north wing and a south wing T of a segment SG, the distances between the segments SG in the west-east direction, the number of segments SG in the solar tracker ST, and the cabling of the equipment inside the solar tracker ST (e.g., the connection of the strings or the connection of the terminal boxes or inverters).

The boundaries of the rectangular outline of the solar tracker ST may result from the tracker design of the solar tracker ST. When configuring the tracker design of the solar tracker ST, the electrical compatibility of the equipment used and restrictions with respect to the extents of the solar tracker ST in the west-east direction and the north-south direction (e.g., on account of permissible wind loads) may be considered.

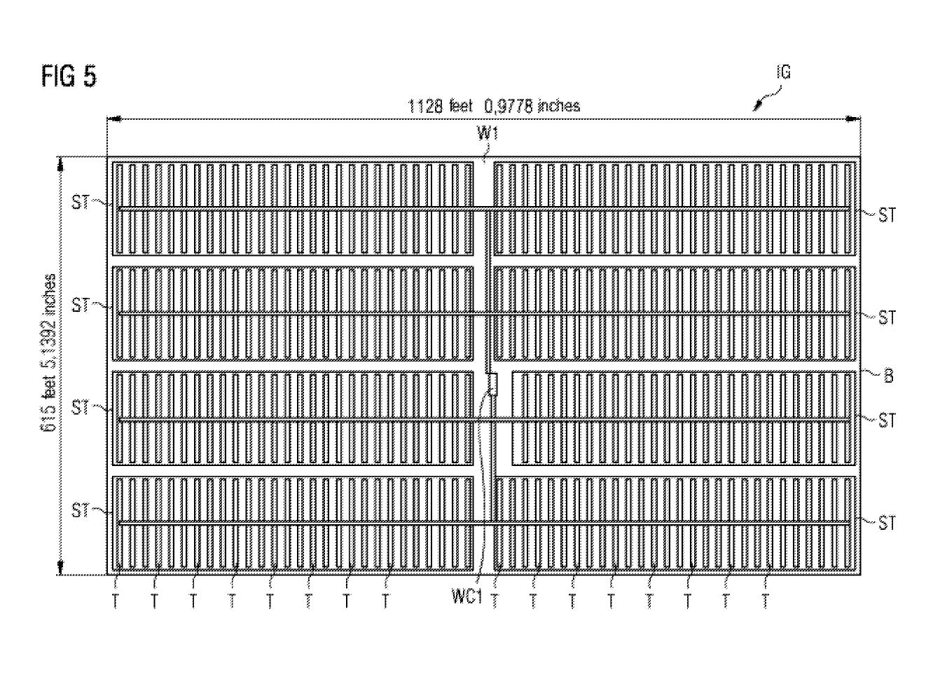

FIG. 5 shows an illustration of an exemplary inverter group of a photovoltaic open-space power plant in accordance with the present teachings.

FIG. 5 illustrates an inverter group IG having eight solar trackers ST. The inverter group IG is referred to as a standard block B because of the rectangular arrangement. The center of FIG. 5 illustrates an inverter container WC1. FIG. 5 also illustrates the cable routing inside the inverter group IG. The cables are routed from the solar trackers ST to the inverter container WC1. A cable and service route W1 runs in the center of the photovoltaic open-space power plant PV in the north-south direction.

An inverter of the photovoltaic open-space power plant PV may have a plurality of DC inputs. A plurality of strings connected in parallel may be connected to the plurality of DC inputs. The number of strings to be connected to an inverter input results from the module data relating to the photovoltaic module, the data relating to the inverter, and the configuration parameters. The number of strings is flexible within a predefined corridor. The flexibility may be taken into account when stipulating the tracker design of the solar tracker ST.

A number of solar trackers ST that is defined by the user is assigned to each inverter. The solar trackers form an inverter group IG. The number of solar trackers ST in an inverter group IG may be determined by the fact that the resulting current intensity that is passed to the inverter of the inverter group IG is compatible with the electrical specification of the inverter, and the resulting current intensity makes optimal use of the inverter capacities.

For this purpose, differently configured solar trackers ST may be combined in an inverter group IG. The number of segments SG per solar tracker ST may vary within an inverter group IG to make optimal use of the capacity of the inverter.

To enable cost-effective and efficient cabling, the inverter container is positioned close to the center of gravity of the inverter group IG. A certain number of segments SG may also be eliminated from a solar tracker ST. As a result, the inverter container WC1 of the inverter group IG may be provided in the space that is obtained by the elimination.

To simplify the cabling and to conserve material, the cables of a plurality of strings may be combined in generator terminal boxes. Similarly, the cables of a plurality of generator terminal boxes may be combined in coupling boxes. Each coupling box is then guided to a DC input of an inverter. The solar trackers ST and the inverters may be placed to provide the optimum prerequisites for DC cabling that is simple, efficient, and cost-effective.

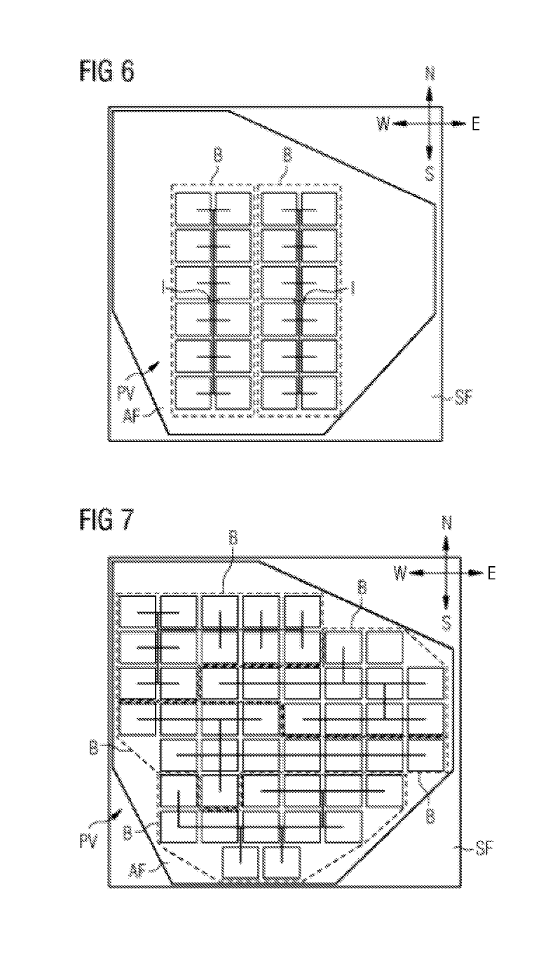

FIGS. 6, 7, and 8 each show an illustration of exemplary system layouts that, in some embodiments, result from different specifications with respect to the arrangement of the solar trackers in the inverter groups.

FIGS. 6 and 7 show, for an exemplary system area AF, the system layouts produced with the software tool for the “standard blocks” and “any desired inverter groups” applications, including the associated cabling. The advantages and disadvantages resulting from the design rules for the respective application are apparent. For the “standard blocks” application, there is a very regular layout with the optimum and/or most favorable cabling results. However, the area utilization is not optimal. By contrast, in the “any desired inverter groups” application, the available system area AF is better used. However, the system layout is not very regular and, as a result, is considerably more complex with regard to cabling and servicing.

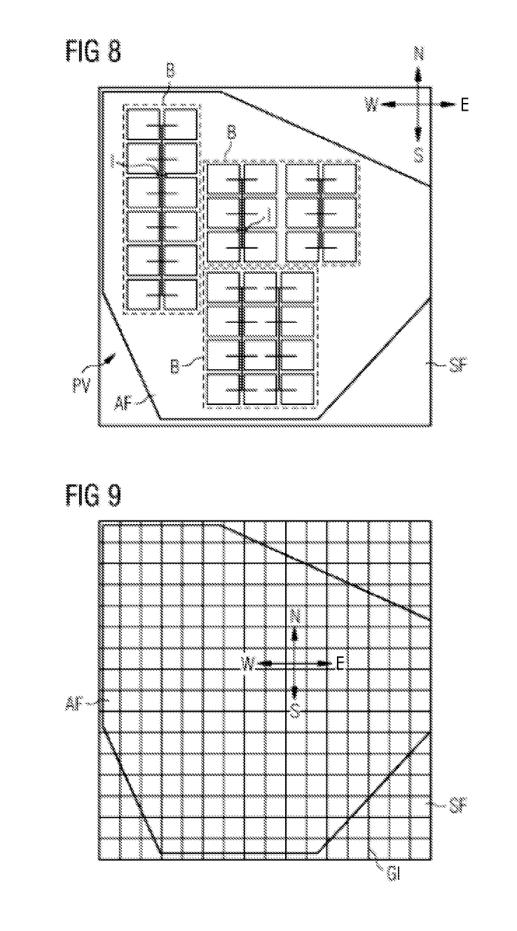

FIG. 8 shows an exemplary system layout that was calculated using the “different standard blocks” application.

If a plurality of different types of standard blocks are used when planning the system layout (e.g., in the “different standard blocks” application), a good compromise is achieved for the given system area AF. The compromise has the above-described advantages of the two “standard blocks” and “any desired inverter groups” applications. The result are shown in FIG. 8.

FIG. 9 shows an illustration of an exemplary tracker route grid in accordance with the present teachings for creating a configuration of a photovoltaic open-space power plant with solar trackers that are arranged in standard blocks. FIG. 9 illustrates a determination of the point of origin of a rigid tracker route grid GI.

Since, in the “different standard blocks” application, continuous routes may run through the available area G or the system area AF in both the north-south direction and the east-west direction, and in order to minimize wasted space, the routes may be arranged in the form of a rigid tracker route grid GI.

The route spacings inside the tracker route grid GI are selected such that each grid cell is sufficiently large that there is space therein for the solar tracker defined by the user with a maximum boundary.

However, only grid cells that are entirely inside the area or system area AF may be used in the final system layout as potential locations of the solar trackers ST. In the rigid tracker route grid GI, the position of each grid cell is determined by the choice of the point of origin of the grid.

The task of this sub-act is to optimally position the origin of the tracker route grid GI, such that the potential solar tracker locations may be optimally grouped in standard blocks B in the subsequent sub-act. For this purpose, the number of potential solar tracker locations may be maximized. In other words, the origin of the tracker route grid GI may be chosen to maximize the number of grid cells that are completely inside the available area or system area AF since the optimization leeway is automatically increased in the next sub-act.

However, due to the predefined standard block formations, maximization of the number of potential solar tracker locations may not provide the optimum prerequisites for the subsequent grouping of the solar trackers ST in standard blocks B. For this reason, a heuristic method may be used for this sub-act to achieve a good intermediate result in the minimum amount of time.

The variable u is used to denote the minimal x coordinate of the area boundary of the system area AF, and the variable v is used to denote the minimal y coordinate of the area boundary of the system area AF. In addition, 1 and h are used to denote the extent of a grid cell in the x-direction and y-direction, respectively. The x coordinate of the grid origin a is then at any desired position inside the range [u; u+1] and the y coordinate b is in the range [v; v+h].

One approach to determining the coordinates of the grid origin is to randomly initialize a and b inside the respective ranges, and then attempt to improve the position as part of a local search. For example, in the x direction, the degree to which the x coordinate a may be shifted to the left or the right without one of the grid cells that were completely inside the area G during initialization crossing the area border may be checked.

If grid cells that were at least partially outside the area may be moved completely into the available area by the shifting, the number of potential solar tracker locations increases. The procedure may also be carried out in a similar manner with the y coordinate b in the y direction. If shifting has been carried out in one of the two directions, the respective other coordinate may then be checked again.

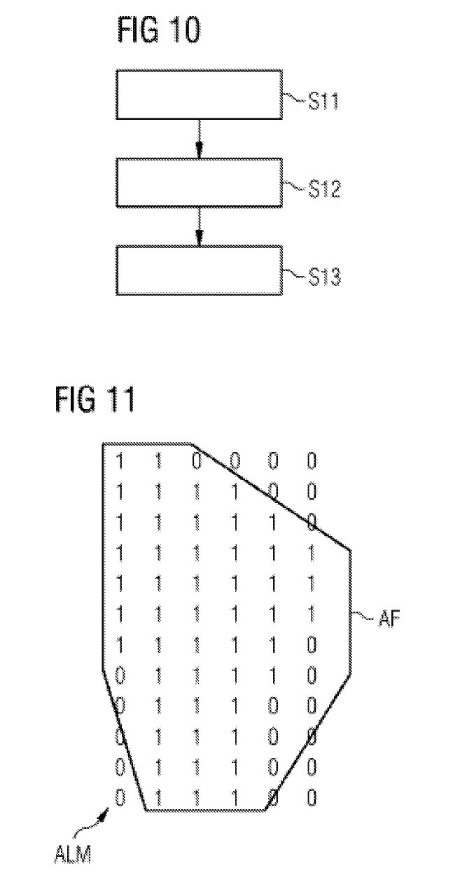

FIG. 10 shows an illustration of a flowchart of an exemplary method in accordance with the present teachings for creating a system layout of a photovoltaic open-space power plant.

Since, for reasons of complexity, the overall problem may not be efficiently solved using a global method (e.g., a method that simultaneously covers all restrictions and target criteria), the problem may be decomposed into sub-problems. The sub-problems may be structured hierarchically and solved in turn for each specific application.

For the “different standard blocks” application, a subdivision into the following sub-acts may be made:

In a first method act S11, the point of origin of a rigid tracker route grid GI is determined.

In a second method act S12, the solar trackers ST that may be placed in the tracker route grid GI are divided into standard blocks B.

In a third method act S13, the calculated system layout of the photovoltaic open-space power plant PV is output and the method is ended, as shown by the flowchart shown in FIG. 10.

FIG. 11 shows an illustration of an exemplary system layout matrix in the form of an area tracker matrix GTM for the tracker route grid shown in FIG. 9.

In a pre-processing act, an area tracker matrix GTM is derived from the tracker route grid GI as a system layout matrix ALM. A standard block alternative matrix SAM is in turn derived as a system layout matrix ALM.

The standard block alternative matrix SAM is used to identify tracker grouping conflicts that may be used to solve the sub-problem of dividing the potential solar tracker locations into standard blocks within the scope of binary linear programming.

To create the area tracker matrix GTM, a matrix element is allocated to each grid cell completely delimited by the tracker route grid GI. The matrix element contains the value 0 if the grid cell is not completely in the available system area AF, and the value 1 if the grid cell corresponds to a potential solar tracker location. The area tracker matrix GTM shown in FIG. 11 results from the starting situation shown in FIG. 9.

Predefined standard block types may be used. For example, three rectangular standard block types each having 12 solar trackers ST may be defined.

FIG. 12 shows an illustration of exemplary different types of standard blocks in accordance with the present teachings for creating a configuration of a photovoltaic open-space power plant with solar trackers.

For the area tracker matrix GI in FIG. 11, the 1 element in the third row and the second column may be used as the left-hand, upper element of the standard block type MB including a 4×3 arrangement of the standard blocks B, as shown in FIG. 12.

The standard block type MA including a 2×6 arrangement of the standard blocks B, and the standard block type MC including a 3×4 arrangement of the standard blocks B, are also shown.

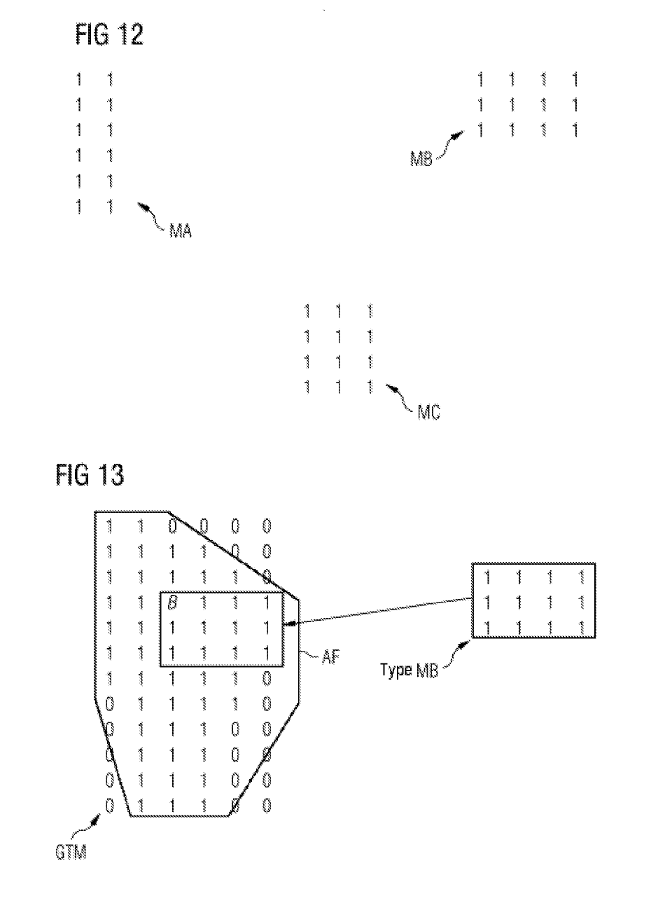

FIGS. 13 to 15 each show an illustration of an exemplary system layout matrix ALM in accordance with the present teachings for creating a configuration of a photovoltaic open-space power plant with solar trackers.

FIG. 13 shows a test that is carried out for all 1 elements of the area tracker matrix GTM and for all standard block types. All letters of the standard block types whose left-hand, upper tracker may be placed there are noted in place of the 1 elements in the area tracker matrix GTM. As a result, the standard block is completely in the area. The standard block alternative matrix SAM is produced in the above-described manner.

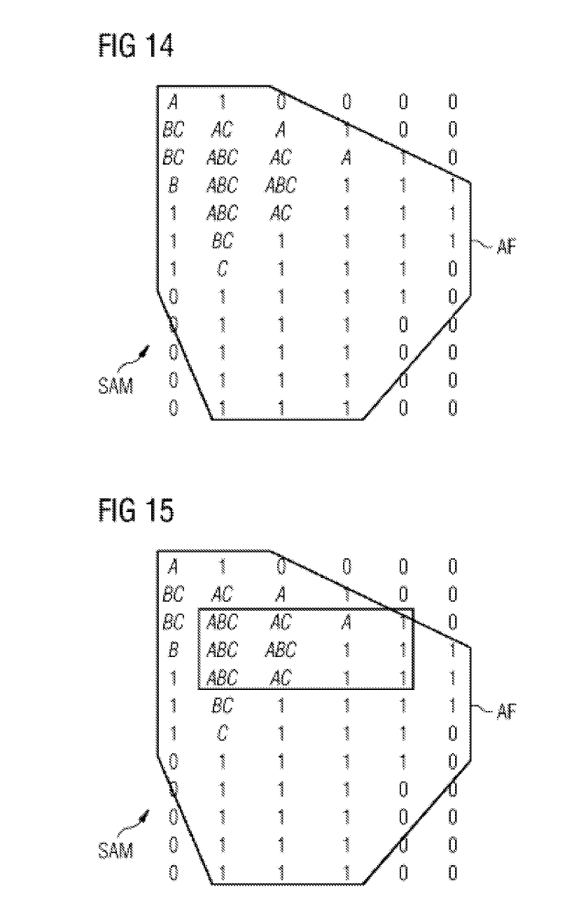

FIG. 14 shows an exemplary standard block alternative matrix SAM generated as described above. The individual matrix elements list the standard block types that may be placed in each case. The standard block alternative matrix SAM shown in FIG. 14 is obtained for the area tracker matrix GTM from FIG. 13.

FIG. 15 shows an example wherein some 1 elements may also be used as the left-hand upper corner of a plurality of standard block types. In this example, a plurality of letters is noted at the corresponding location in the standard block alternative matrix.

Some grouping alternatives may exclude each other since the grouping alternatives partially resort to the same potential solar tracker locations.

Two grouping alternatives form a solar tracker grouping conflict if the sub-matrices belonging to the grouping alternatives are not free of overlap in the area tracker matrix GI.

The set of all pairs of grouping alternatives (X, Y) that forms a tracker grouping conflict for a standard block alternative matrix is denoted as K. The calculation of the set K forms the conclusion of the pre-processing for solving the sub-problem in act S12.

The set K of all solar tracker grouping conflicts determined during pre-processing is used to model the sub-problem of grouping the potential solar tracker locations in standard blocks B. The modeling is carried out using a binary linear program (e.g., a special case of mixed-integer linear programming).

The central part of the binary linear program is formed by the binary variables x that indicate, for each grouping alternative i, whether the binary variables are used in the system layout (e.g., Xi assumes the value 1) or are not used in the system layout (e.g., Xi assumes the value 0).

As further designators, the method may use the number n of grouping alternatives and the weighting factors Wj that stipulate, for each standard block type j, a weight that may be used to prioritize the selection of certain standard block types with respect to other standard block types.

For example, the most favorable cabling results for standard block type A, the second-most favorable cabling results for type B, and the cabling with the longest cable lengths results for type C may be represented by weighting. For example, wA=10, wB=8 and wC=7 may be chosen as weights.

As a result, the grouping of three standard blocks B of type A may be given preference over the grouping of four standard blocks B of type C (e.g., even though less power would be installed in the photovoltaic open-space power plant PV).

The choice of the weighting factors may be the user's responsibility or predefined by the program itself. In addition, all standard block types may be equally weighted, such that the installed power in the field is maximized.

The model also uses a designator t(i) that identifies the associated standard block type for a grouping alternative i. The following binary linear program for solving the sub-problem of dividing the potential solar tracker locations into standard blocks B may be used:

The area data, the tracker route grid GI including the origin, the standard block types including the prioritization weight w, and the set K of solar tracker grouping conflicts that is already determined from the data during pre-processing may be used as the input.

The solar trackers ST are positioned completely in the available area or system area AF. This restriction is achieved by calculating the area tracker matrix GTM.

Furthermore, an overlap-free grouping of the potential solar tracker locations in standard blocks B may be provided as a restriction. This restriction is achieved because the sum of the binary variables of two solar tracker grouping alternatives for which there is a solar tracker grouping conflict may, at most, assume the value 1. As a result, at most one of these two alternatives may be selected.

In addition, compliance with the predefined rectangular formations of the standard block types during grouping may be used as a restriction. This restriction is achieved by calculating the standard block alternative matrix SAM.

Maximization of the weighted sum of the selected grouping alternatives of standard block types may be used as a target function.

Positioning of the solar trackers ST and/or grouping of the solar trackers ST in standard blocks B may be output as the output.

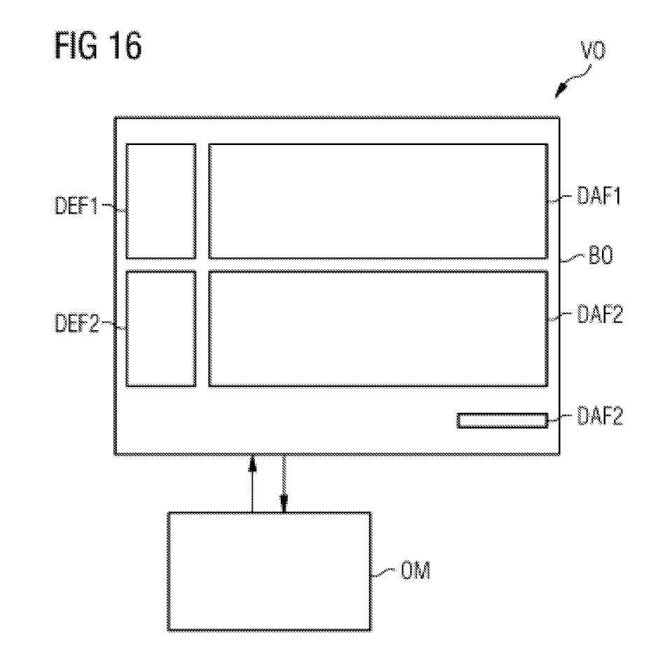

FIG. 16 shows an illustration of an exemplary user interface module for inputting data in accordance with the present teachings.

A device VO for creating a system layout of a photovoltaic open-space power plant PV includes an optimization module OM and a user interface module BO.

For example, special windows are defined and shown in a graphical or character-oriented user interface as dialog windows, dialog fields, or dialog boxes.

For example, the user interface module BO includes a multiplicity of dialog windows that are constructed in a form-like manner and are provided for inputting data. Standard widgets such as data display fields DAF1-DAF3 and checkboxes may be used for this purpose.

The user interface module BO also has data input fields DEF1-DEF2 and, as a result, provides functionalities for inputting and managing the basic data (e.g., data relating to the solar trackers ST, data relating to the types of inverters used, data relating to the area G, and optionally additional data).

The area data input dialog facilitates definition of area and barred area outlines for the area G.

A further menu may provide functionalities for selecting area data and components, and for inputting parameters. In addition, information (e.g., relating to the results of a physical or circuitry test of the solar cell table arrangement) may be presented.

For example, after clicking a button, an optimization run is started and an optimization page is opened. Brief information relating to the optimization order currently being processed by the optimization module, and a status display that provides information on the program progress, appear.

After the optimization run has ended, a brief summary of the results appears. The results are processed in detail by clicking a further button. The report page opens after the processing of the results has ended. The optimization results may be displayed in the form of graphics with an interaction and zoom function or as result or data lists.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding claim—whether independent or dependent—and that such new combinations are to be understood as forming a part of the present specification.

1. A method for creating a system layout of a photovoltaic open-space power plant, the method comprising:
providing configuration data for the photovoltaic open-space power plant and components thereof, predefined configuration rules for the photovoltaic open-space power plant, and configuration parameters that define the configuration rules; and
optimizing positioning of the components of the power plant in a system layout matrix, wherein the system layout matrix maps an area for the photovoltaic open-space power plant, using the configuration data and the defined configuration rules to create the system layout of the photovoltaic open-space power plant;
wherein number of solar trackers in the system layout of the photovoltaic open-space power plant is maximized when the positioning of the components is optimized;
wherein a rigid tracker route grid is arranged in the area in this case; and
wherein the origin of the tracker route grid is positioned such that the number of grid cells is maximized.

2. The method of claim 1, wherein the components of the power plant comprise solar trackers, wherein the components are positioned such that the solar trackers are divided into a plurality of inverter groups, and wherein each inverter group of the plurality of inverter groups forms a standard block.

3. The method of claim 2, wherein the standard block is rectangular.

4. The method of claim 2, wherein a form of the standard block is selected from a plurality of different types of standard blocks.

5. The method of claim 2, further comprising maximizing the inverter groups used as a target function to create the system layout of the photovoltaic open-space power plant.

6. The method of claim 5, wherein different types of standard blocks are included in the target function with different weightings in the maximizing of the inverter groups.

7. The method of claim 1, further comprising using at least two system layout matrices to optimize the positioning of the components.

8. The method of claim 1, further comprising checking compatibility of the components of the power plant.

9. The method of claim 1, wherein the configuration data comprises data relating to a position, an outline, or a position and an outline of an area for the photovoltaic open-space power plant.

10. The method of claim 1, further comprising using an optimization module to create the system layout of the photovoltaic open-space power plant, wherein the optimization module comprises a plurality of algorithms and is configured to use a plurality of calculation methods to plan and install the photovoltaic open-space power plant.

11. The method claim 10, further comprising using a user interface module to carry out the method, wherein the user interface module comprises a graphical user interface having functionalities selected from the group consisting of inputting data, managing data, outputting data, and combinations thereof, and wherein the graphical user interface is configured to call the optimization module, to display results, or to call the optimization module and to display results.

12. A device for creating a system layout of a photovoltaic open-space power plant, the device comprising an optimization module configured to
provide configuration data for the photovoltaic open-space power plant and components thereof, predefined configuration rules for the photovoltaic open-space power plant, and configuration parameters that define the configuration rules; and
optimize positioning of the components of the power plant in a system layout matrix, wherein the system layout matrix maps an area for the photovoltaic open-space power plant, using the configuration data and the defined configuration rules to create the system layout of the photovoltaic open-space power plant;
wherein number of solar trackers in the system layout of the photovoltaic open-space power plant is maximized when the positioning of the components is optimized;
wherein a rigid tracker route grid arranged in the area; and
wherein the origin of the tracker route grid is positioned such that the number of grid cells is maximized.

13. A non-transitory computer-readable storage medium having stored therein data representing instructions executable by a programmed processor for creating a system layout of a photovoltaic open-space power plant, the storage medium comprising instructions for:
providing configuration data for the photovoltaic open-space power plant and components thereof, predefined configuration rules for the photovoltaic open-space power plant, and configuration parameters that define the configuration rules; and
optimizing positioning of the components of the power plant in a system layout matrix, wherein the system layout matrix maps an area for the photovoltaic open-space power plant using the configuration data and the defined configuration rules to create the system layout of the photovoltaic open-space power plant;
wherein number of solar trackers in the system layout of the photovoltaic open-space power plant is maximized when the positioning of the components is optimized;
wherein a rigid tracker route grid is arranged in the area; and
wherein the origin of the tracker route grid is positioned such that the number of grid cells is maximized.

14. The method of claim 3, wherein a form of the standard block is selected from a plurality of different types of standard blocks.

15. The method of claim 3, further comprising maximizing the inverter groups used as a target function to create the system layout of the photovoltaic open-space power plant.

16. The method of claim 4, further comprising maximizing the inverter groups used as a target function to create the system layout of the photovoltaic open-space power plant.

17. The method of claim 3, wherein different types of standard blocks are included in the target function with different weightings in the maximizing of the inverter groups.

18. The method of claim 4, wherein different types of standard blocks are included in the target function with different weightings in the maximizing of the inverter groups.

19. The method of claim 3, further comprising using at least two system layout matrices to optimize the positioning of the components.

20. The method of claim 4, further comprising using at least two system layout matrices to optimize the positioning of the components.
